(19) United States
(12) Patent Application Publication
(10) Pub. No.: US 2005/0175189 A1
(43) Pub. Date: Aug. 11, 2005

(54) DUAL MICROPHONE COMMUNICATION DEVICE FOR TELECONFERENCE

(76) Inventors: Yi-Bing Lee, Taipei (TW); Xiao Dong Li, Beijing (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,670

(22) Filed: Sep. 30, 2004

(30) Foreign Application Priority Data
Feb. 6, 2004 (TW) 93102734

(51) Int. Cl. H04R 3/00; H04M 9/08

(52) U.S. Cl. 381/92

(57) ABSTRACT

A dual microphone communication device comprising a first microphone module, a second microphone module and a mixer circuit is provided. The first microphone module amplifies a near-end audio signal to produce a first audio signal. The second microphone module receives and amplifies the near-end audio signal by a fixed gain and a constant phase difference to produce a second audio signal. The mixer circuit subtracts the second audio signal from the first audio signal to produce a third audio signal so that interference resulting from echoes is significantly reduced while keeping, or enhance the near end voice level.

### CROSS-REFERENCE TO RELATED APPLICATION

This application claims the priority benefit of Taiwan application serial no. 93102734, filed Feb. 06, 2004.

### BACKGROUND OF THE INVENTION

1. Field of the Invention

The present invention relates to a dual microphone communication device. More particularly, the present invention relates to a communication device for teleconference.

2. Description of the Related Art

With the advent of Internet communication, wide-area or transnational conference using a teleconference system has become a common affair especially for international companies. In the past, cooperations have to spend a large sum of money just for monitoring the business in various branches. With the introduction of teleconference, the operations in each and every branches can be effectively controlled and administrative instructions can be distributed beyond the boundaries of countries without delays.

FIG. 1A is a schematic block diagram of a conventional teleconference system. As shown in FIG. 1A, a conventional teleconference system 100 (for example, a video conferencing system) has a control unit 108 that couples to a loudspeaker 104 and a microphone 102. Through a communication network 122 such as a public switching telephone network (PSTN), the control unit 108 is able to receive a far-end audio signal from a far-end communication terminal 124 and output sound through the loudspeaker 104 accordingly. In the meantime, the microphone 102 picks up a near-end audio signal produced by a user. The control unit 108 receives the near-end audio signal and converts the signal into an electrical audio signal before transmitting the electrical audio signal to the far end communication terminal 124 via the communication network 122.

One of the major issues in a conventional teleconference system is the reduction of interfering echoes. As shown in FIG. 1, when the loudspeaker 104 of the teleconference system 100 emits the sound according to the far-end audio signal, acoustic echoes will be fed back via the microphone 102 into the teleconference system 100 to form a loop. The loop back transmission will produce some annoying far-end echoes. If there is a series system mismatch, howling sound is often produced causing a significant drop in transmission quality. To minimize acoustic feedback, a simplex communication method is frequently deployed. In other words, the microphone 102 is shut when the loudspeaker 104 output sound. Conversely, the loudspeaker 104 is shut when the microphone 102 receives acoustic signals. One major defect of this communication method is voice clipping. Because the microphone 102 and the loudspeaker 104 has to be alternately shut during system communication, it is possible that an announcement has to be cut before its ending so that another user can cut in to use the microphone 102. In this way, critical parts of an important message may be lost.

FIG. 1B is a schematic block diagram of another conventional teleconference system. Another technique for reducing acoustic feedback is to use a duplex teleconference system 100 as shown in FIG. 1B. An echo feedback processing circuit 106 is added to the back of the microphone 102. The echo feedback processing circuit 106 is capable of filtering away echo signals picked up by the microphone 102. However, the echo feedback processing circuit 106 has an ultimate processing limit. When the feedback acoustic signal exceeds a largest permissible magnitude, the residual echo will be out of control, worse still, system howling can be triggered. In particular, the capacity of the echo feedback processing circuit 106 to remove echoes is easily exceeded when the microphone 102 and the loudspeaker 104 are positioned close to each other.

Another conventional method of reducing the echo feedback is to lower the gain of the microphone 102. However, using this method, the listener at the far end of the line can hardly hear the sound of a user speaking at the near end if the microphone 102 is positioned at a location slightly further away from the user. To be heard, the user may have to raise one's voice resulting in great discomfort.

### SUMMARY OF THE INVENTION

Accordingly, at least one objective of the present invention is to provide a dual microphone communication device and communication method for a teleconference system that permits duplex communication without triggering any howling in the system.

At least a second objective of the present invention is to provide a dual microphone communication device and communication method for a teleconference system that maintains a high communication quality despite setting the microphone and loudspeaker close to each other.

At least a third objective of the present invention is to provide a dual microphone communication device and communication method for a teleconference system that increases the gain of the system but without triggering any howling in the system.

To achieve these and other advantages and in accordance with the purpose of the invention, as embodied and broadly described herein, the invention provides a dual microphone communication device for a telecommunication system in a video teleconference. The dual microphone communication device comprises a first microphone module, a second microphone module and a mixer circuit. The first microphone module receives a near-end audio signal from a user. The first microphone module amplifies the near-end audio signal to produce a first audio signal. Similarly, the second microphone module receives the near-end audio signal. However, the second microphone module has a fixed gain. Furthermore, on receiving the near-end audio signal, the second microphone module produces a second audio signal having a constant phase difference from the original near-end audio signal. The mixer circuit receives the first audio signal and the second audio signal and subtracts the second audio signal from the first audio signal to produce a third audio signal. Although the third audio signal is formed by signal subtraction, the ear of a human listener can hardly distinguish the difference between the first audio signal and the third audio signal. Hence, the third audio signal is able to suppress interfering echoes without compromising the clarity of the user.

The dual microphone communication device of the present invention further comprises a loudspeaker and a control unit. The control unit is coupled to the mixer circuit and the loudspeaker. Through a particular communication network, a far-end audio signal from a far-end communication terminal is transmitted to the loudspeaker and broadcast. Similarly, the control unit converts the third audio signal produced by the mixer circuit into electrical audio frequency signal and transmits to the far-end communication terminal via the communication network.

In one embodiment of the present invention, the first microphone and the second microphone are set to a predetermined direction for receiving the near-end audio signal. The loudspeaker is set up within a direction range just opposite to the predetermined direction. Moreover, the loudspeaker outputs far-end audio signal in a direction opposite to the direction in which the first microphone and the second microphone receives the near-end audio signal. In general, the near-end audio signal comprises the output from the loudspeaker or the voice output from the user.

Preferably, the first microphone module comprises a first microphone and a gain modulation circuit. The first microphone receives the near-end audio signal and transmits the signal to the gain modulation circuit. After receiving the near-end audio signal from the first microphone, the gain modulation circuit amplifies the near-end audio signal to produce a first audio signal. The first audio signal is transmitted to the mixer circuit.

The second microphone module comprises a second microphone and a phase-shift circuit. Similarly, the second microphone receives the near-end audio signal and transmits the signal to the phase-shift circuit. The phase-shift circuit has a fixed gain. After receiving the near-end audio signal from the second microphone, the phase-shift circuit shifts the phase of the near-end audio signal to produce a second audio signal. Thereafter, the phase-shift circuit transmits the second audio signal to the mixer circuit.

In one embodiment of the present invention, the mixer circuit comprises a subtraction unit with a first signal input terminal and a second signal input terminal. The first signal input terminal receives the first audio signal and the second signal input terminal receives the second audio signal. Furthermore, the subtraction unit performs a subtraction of the second audio signal from the first audio signal and produces a third audio signal according to the difference in the subtraction.

The present invention also provides a teleconference system comprising an input module, an output module, a control unit and a communication network. The control unit is coupled to the input module and the output module. The input module has a first audio signal input terminal and a second audio signal input terminal for receiving a near-end audio signal. As soon as the near-end audio signal is fed into the first audio input terminal, the near-end audio signal is amplified to produce a first audio signal. Similarly, as soon as the near-end audio signal is fed into the second audio input terminal, the input module fixes the gain of the near-end audio signal and shift the phase of the near-end audio signal to produce a second audio signal with a phase difference. Furthermore, the input module also subtracts the second audio signal from the first audio signal to produce a third audio signal. The control unit picks up the third audio signal and converts the signal into an electrical audio frequency signal. The electrical audio frequency signal is transmitted via the communication network to a far-end communication terminal. Conversely, the control unit also picks up a far-end audio signal from the far-end communication terminal via the communication network and outputs the signal through the output module.

In one embodiment of the present invention, the input module is set in a predetermined direction for receiving the near-end audio signal. The output module is set in a direction within a range just opposite to the predetermined direction. Furthermore, the direction in which the output module outputs the far-end audio signal is opposite to the direction in which the input module receives the near-end audio signal. In general, the output module is a loudspeaker and the near-end audio signal includes the output from the output module or the voice output from a user.

The input module further comprises a gain modulation circuit, a phase-shift circuit and a subtraction unit. The gain modulation circuit is coupled to the first audio input terminal of the input module for amplifying the near-end audio signal to produce the first audio signal. The phase-shift circuit is coupled to the second audio input terminal for providing the near-end audio signal with a fixed gain and shifting the phase to produce the second audio signal. The subtraction unit has a first signal input terminal and a second signal input terminal. The first signal input terminal receives the first audio signal and the second signal input terminal receives the second audio signal. After receiving the first audio signal and the second audio signal, the subtraction unit subtracts the second audio signal from the first audio signal and produces the third audio signal according to the difference in the subtraction.

The present invention also provides a communication method for conducting a teleconference. First, a near-end communication terminal picks up a near-end audio signal. The near-end audio signal is amplified to produce a first audio signal. Furthermore, the gain of the near-end audio signal is also fixed and the phase of the signal is shifted to produce a second audio signal. Finally, the second audio signal is subtracted from the first audio signal to produce a third audio signal and the third audio signal is transmitted to a far-end communication terminal.

The step of transmitting the third audio signal to the far-end communication terminal further includes converting the third audio signal to an electrical audio frequency signal and then transmitting the electrical signal via a communication network to the far-end communication terminal.

In brief, the third audio signal sent from the dual microphone communication device according to the present invention to another communication terminal is a signal obtained by subtracting the second audio signal from the first audio signal. After such audio signal processing, the direct feedback portion of the content from the speaker is attenuated. Hence, the present invention permits duplex communication and has a higher system gain without triggering any howling in the system.

In addition, the input module is set in a predetermined direction for receiving the near-end audio signal and the output module is set in a direction within a range just opposite to the predetermined direction. Furthermore, the direction in which the output module outputs the far-end audio signal is opposite to the direction in which the input module receives the near-end audio signal. Hence, a high communication quality can be maintained despite setting the microphone and the loudspeaker close to each other

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a schematic block diagram of a conventional teleconference system.

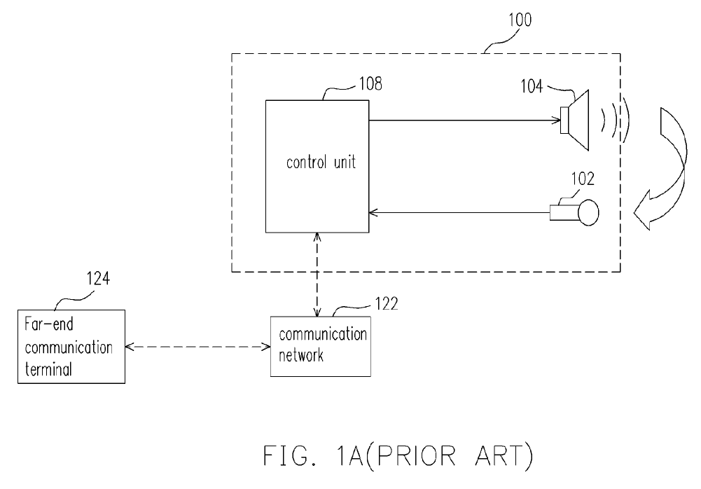

FIG. 1B is a schematic block diagram of another conventional teleconference system.

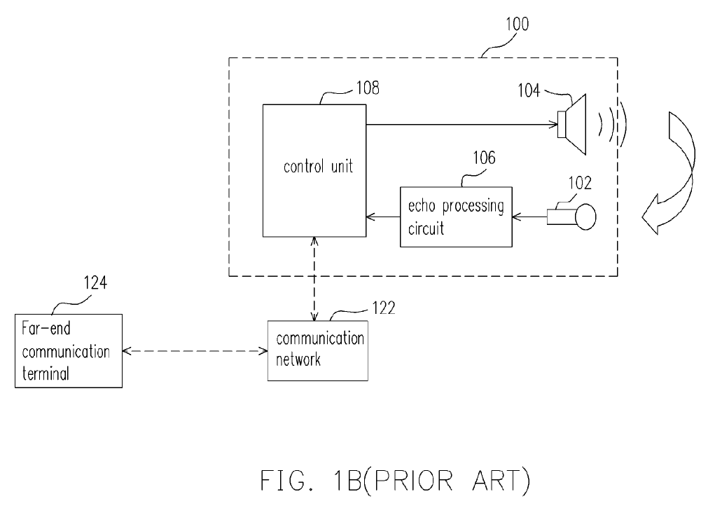

FIG. 2 is a schematic block diagram showing an electrical transmission system according to one preferred embodiment of the present invention.

FIG. 3 is a schematic block diagram showing a dual microphone communication device according to one preferred embodiment of the present invention.

FIG. 4 is a flowchart showing a method for carrying out a teleconference according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

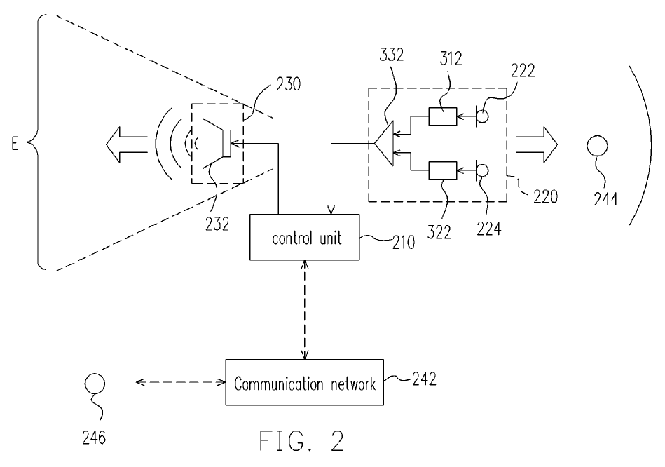

FIG. 2 is a schematic block diagram showing an electrical transmission system according to one preferred embodiment of the present invention. As shown in FIG. 2, a control unit 210 is coupled to an input module 220, an output module 230 and a communication network 242. A group of people 244 may use the device of this invention to communicate with another group of people 246 through a communication network 242 such as a public telephone exchange network. First, a near-end audio signal (for example, the audio frequency signal output from the output module 230 and the sound produced by the group of people 244) produced by the group of people 244 is fed into the input module 220. Thereafter, the control unit 220 converts the near-end audio signal into an electrical audio frequency signal and the audio frequency signal is transmitted to the group of people 246 through the communication network 242. Similarly, a far-end audio signal produced by the group of people 246 is also transmitted as an electrical audio frequency signal via the communication network 242 to the control unit 210 and then the audio frequency signal is converted into a far-end audio signal. Thereafter, the output module 230 produces an audio message according to the far-end audio signal.

As shown in FIG. 2, the input module 220 receives the near-end audio signal by facing the direction where the group of people 244 is located. Thus, the input module 220 is exceptionally sensitive to the sound produced by the group of people 244. In addition, to minimize interference due to echoes, the output module 230 is set up in a direction within a predetermined range E and the predetermined range E is in a direction opposite to the direction in which the input module 220 receives the near-end audio signal. Furthermore, the direction in which the output module 230 outputs audio signal is also opposite to the direction in which the input module receives the audio signal. In other words, the output module 230 outputs audio signal in a direction away from the group of people 244. Hence, the input module 220 picks up very little echoes. Meanwhile, the group of people 244 is able to hear the voice message produced by the output module 230 as echoes.

The input module 220 has a first audio signal input terminal 222 and a second audio signal input terminal 224 for receiving the near-end audio signal. The audio signal picked up by the respective audio input terminal can interact with each other to enhance acoustic effect and minimize echo interference.

Although mutual communication between two groups of people 244 and 246 is illustrated in FIG. 2, the communication device is not limited to group communication. In fact, the communication device of the present invention can be used for person-to-person or person-to-group communication.

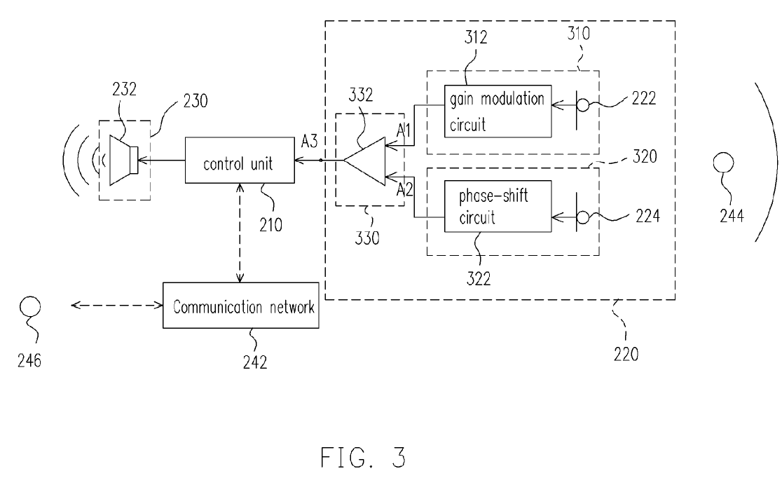

FIG. 3 is a schematic block diagram showing a dual microphone communication device according to one preferred embodiment of the present invention. As shown in FIG. 3, the output of a first microphone module 310 and a second microphone module 320 inside the input module 220 are coupled to a mixer circuit 330. The output terminal of the mixer circuit 220 is coupled to a control unit 210. On receiving a near-end audio signal, the first microphone module 310 produces a first audio signal A1 and the second microphone module 320 produces a second audio signal A2. The mixer circuit 330 produces a third audio signal A3 according to the first audio signal A1 and the second audio signal A2. Thereafter, the third audio signal A3 is transmitted to the control unit 210. The control unit 210 converts the third audio signal A2 into an electrical audio frequency signal and transmits the audio frequency signal via a communication network 242 to a group of people 246. Similarly, the group of people 246 responds by sending a far-end audio signal back to the control unit 210 so that the sound is produced by an output module 230. In this embodiment, the output module is a loudspeaker 232, for example.

In FIG. 3, the output terminal of the audio input terminal 222 of the first microphone 310 is coupled to a gain modulation circuit 312. After receiving a near-end audio signal, the audio signal input terminal 222 transmits the near-end audio signal to the gain modulation circuit 312 and then the signal is amplified to produce a first audio signal Al.

Similarly, the output terminal of the audio input terminal 224 of the second microphone 320 is coupled to a phase-shift circuit 322. The phase-shift circuit 322 has a fixed gain. After receiving a near-end audio signal, the audio signal input terminal 224 transmits the near-end audio signal to the phase-shift circuit 322 and then the phase of the signal is shifted by a definite amount to produce a second audio signal A2. In general, the second audio signal A2 can have a phase lagging behind or ahead the phase of the first audio signal A1. In addition, the gain of the phase-shift circuit 322 and the amount of phase shift in the second audio signal A2 relative to the first audio signal A1 depend on the quality of audio reception of the second microphone 320.

The mixer circuit 330 may further comprise a subtraction unit 332. When the subtraction unit 332 receives the first audio signal A1 and the second audio signal A2, the second audio signal A2 is subtracted from the first audio signal A1. According to the difference in the subtraction, the subtraction nit 332 produces a third audio signal A3 that are transmitted to the control unit 210. The purpose of subtracting the second audio signal A2 from the first audio signal A1 is to filter away a portion of the echoes and hence reduce echoes that might cause undesirable interference. Because the second audio signal A2 has a relatively low gain, the subtraction of the second audio signal A2 from the first audio signal A1 has minimal effect on the human hearing. Since the human ear can hardly distinguish any difference after the subtraction, the group of people 246 can clearly hear what the group of people 244 says. Furthermore, the gain of the phase-shift circuit 322 and the amount of phase shift in the second audio signal A2 can be determined by testing the quality of the third audio signal A3 in repeated trails.

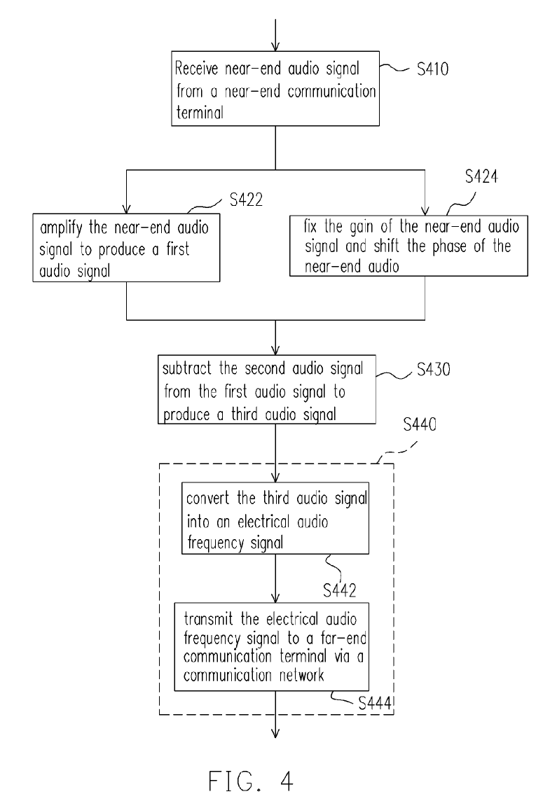

FIG. 4 is a flowchart showing a method for carrying out a teleconference according to one preferred embodiment of the present invention. First, in step S410, a near-end audio signal produced by a near-end communicator is received. In step S422, the near-end audio signal is amplified to produce a first audio signal. Meanwhile, in step S424, the near-end audio signal is processed to produce a second audio signal with a fixed gain and a definite phase shift. The phase of the second audio signal may lead or lag the phase of the first audio signal. Thereafter, in step S430, the second audio signal is subtracted from the first audio signal and a third audio signal is produced according to the difference in the subtraction. Finally, in step S440, the third audio signal is transmitted to a far-end communication terminal.

Step S440 in FIG. 4 can be split into two separate sub-steps. First, in step S442, the third audio signal in analogue format is converted into an electrical audio frequency signal in digital format. Thereafter, in step S444, the electrical audio frequency signal is transmitted to the far-end communication terminal through a communication network such as a public telephone network.

In summary, major advantages of the present invention includes:

1. A dual microphone module is provided so that two audio signals can be subtracted to obtain a modified audio signal capable of minimizing interference due to echoes but without attenuating the gain of the microphone.

2. The direction in which the output module outputs the far-end audio signal is different from the direction in which the input module outputs the near-end audio signal. Furthermore, the output module is set up within a predetermined direction range just opposite to the direction in which the input module receives the near-end audio signal. Hence, the output module and the input module can be very close together without causing too much interference from echoes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A dual microphone module communication device for a teleconference system, comprising, within each microphone port (a teleconference system can have multiple microphone ports):
a first microphone module for receiving a near-end audio signal and amplifying the near-end audio signal to produce a first audio signal;
a second microphone module for receiving the near-end audio signal, wherein the second microphone module has a fixed gain and the second microphone module shifts a phase of the near-end audio signal to produce a second audio signal with a phase difference relative to the near-end audio signal; and
a mixer circuit for receiving the first audio signal and the second audio signal and subtracting the second audio signal from the first audio signal to produce a third audio signal.

2. The communication device of claim 1, wherein the device further comprises:
a loudspeaker; and
a control unit coupled to the mixer circuit and the loudspeaker, wherein the control unit receives a far-end audio signal from a far-end communication terminal via a communication network and broadcasts the far end audio signal through the loudspeaker, and the control unit also converts the third audio signal into an electrical audio frequency signal and transmits the audio frequency signal to the far-end communication terminal via the communication network.

3. The communication device of claim 2, wherein the first microphone and the second microphone faces a predetermined direction for receiving the near-end audio signal and the loudspeaker faces a direction within a range just opposite to the predetermined direction, and the direction in which the loudspeaker outputs the far-end audio signal is opposite to the predetermined direction.

4. The communication device of claim 1, wherein the first microphone module further comprises:
a first microphone for receiving the near-end audio signal; and
a gain modulation circuit coupled to the output terminal of the first microphone for amplifying the near-end audio signal to produce the first audio signal and transmitting the first audio signal to the mixer circuit.

5. The communication device of claim 1, wherein the second microphone module further comprises:
a second microphone for receiving the near-end audio signal; and
a phase-shift circuit coupled to the output terminal of the second microphone, wherein the phase-shift circuit has a fixed gain and the phase-shift circuit shifts the phase of the near-end audio signal to produce the second audio signal with a phase difference relative to the near-end audio signal before sending the second audio signal to the mixer circuit.

6. The communication device of claim 1, wherein the mixer circuit further comprises a subtraction unit with a first signal input terminal and a second signal input terminal such that the subtraction unit subtracts the second audio signal from the first audio signal to produce the third audio signal after the first signal input terminal has received the first audio signal and the second signal input terminal has received the second audio signal.

7. The communication device of claim 1, wherein the near-end audio signal further comprises an acoustic signal produced by a user or a loudspeaker.

8. A teleconference system, comprising:
a control unit;
an input module, having a first audio signal input terminal and a second audio signal input terminal for receiving a near-end audio signal, wherein the near-end audio signal fed to the first audio signal input terminal is amplified to produce a first audio signal, the near-end audio signal fed to the second audio signal input terminal is provided with a fixed gain and phase-shifted to produce the second audio signal with a phase difference relative to the near-end audio signal, and the input module also subtracts the second audio signal from the first audio signal to produce a third audio signal;
an output module for outputting a far-end audio signal; and
a communication network coupled to the control unit and a far-end communication terminal,
wherein the control unit picks up the far-end audio signal from the far-end communication terminal via the communication network and broadcasts the audio message through the output module, and the control unit also transmits the third audio signal to the far-end communication terminal via the communication network.

9. The teleconference system of claim 8, wherein the input module faces a predetermined direction for receiving the near-end audio signal and the output module faces a direction within a range just opposite to the predetermined direction, and the direction in which the output module outputs the far-end audio signal is opposite to the predetermined direction.

10. The teleconference system of claim 8, wherein the input module further comprises:
a gain modulation circuit coupled to the first audio signal input terminal for amplifying the near-end audio signal to produce the first audio signal;
a phase-shift circuit coupled to the second audio signal input terminal for fixing the gain of the near-end audio signal and shifting the phase of the near-end audio signal by a definite amount to produce the second audio signal; and
a subtraction unit with a first signal input terminal, a second signal input terminal and an output terminal, wherein the subtraction unit subtracts the second audio signal from the first audio signal to produce the third audio signal at the output terminal after the first signal input terminal has received the first audio signal and the second signal input terminal has received the second audio signal.

11. The teleconference system of claim 8, wherein the output module comprises a loudspeaker.

12. The teleconference system of claim 8, wherein the communication network comprises a public telephone exchange network.

13. The teleconference system of claim 8, wherein the near-end audio signal comprises an acoustic signal produced by a user of an output module.

14. A method of carrying out a teleconference, comprising:
receiving a near-end audio signal from a near-end communication terminal; amplifying the near-end audio signal to produce a first audio signal;
fixing the gain of the near-end audio signal and shifting the phase of the near-end audio signal by a definite amount to produce a second audio signal; and
subtracting the second audio signal from the first audio signal to produce a third audio signal and transmitting the third audio signal to a far-end communication terminal.

15. The method of claim 14, wherein the step of transmitting the third audio signal to the far-end communication terminal comprises:
converting the third audio signal into an electrical audio frequency signal; and
transmitting the electrical audio frequency signal to the far-end communication terminal via a communication network.

16. The method of claim 14, wherein the communication network comprises a public telephone exchange network.

17. The method of claim 14, wherein the near-end audio signal comprises an acoustic signal produced by at least one user.
